(19) United States
(12) Patent Application Publication
(10) Pub. No.: US 2026/0012232 A1
(43) Pub. Date: Jan. 8, 2026

(54) CHANNEL ESTIMATION FOR ULTRA-MASSIVE MULTIPLE INPUT MULTIPLE OUTPUT AT TERAHERTZ BAND

(71) Applicant: Nokia Solutions and Networks Oy, Espoo (FI)

(72) Inventors: Hao LIU, Shanghai (CN); Tao YANG, Shanghai (CN)

(21) Appl. No.: 19/126,212

(22) PCT Filed: Oct. 31, 2022
(86) PCT No.: PCT/CN2022/128818

§ 371 Date: Apr. 30, 2025

(51) Int. Cl. H04B 7/0452; H04B 7/0456; H04L 25/02

(52) U.S. Cl. CPC H04B 7/0452; H04B 7/0456; H04L 25/0204

(57) ABSTRACT

Embodiments of the present disclosure disclose devices, methods, apparatuses and computer readable storage media of channel estimation for Ultra-Massive Multiple Input Multiple Output (UM-MIMO) at Terahertz (THz) band. The method comprises obtaining a first codebook matrix associated with a first antenna arrangement at the first device and a second codebook matrix associated with a second antenna arrangement at a second device, wherein a first plurality of subarrays in the first antenna arrangement are spaced at a predetermined distance from each other, and wherein a second plurality of subarrays in the second antenna arrangement are spaced at a predetermined distance from each other, and characterizing a channel between the first device and the second device at least based on the first and the second codebook matrices.

### FIELD

Various example embodiments of the present disclosure generally relate to the field of telecommunication and in particular, to methods, devices, apparatuses and computer readable storage medium of channel estimation for Ultra-Massive Multiple Input Multiple Output (UM-MIMO) at Terahertz (THz) band.

### BACKGROUND

Owning abundant bandwidth of multi-GHz up to even THz, the THz spectrum ranging from 0.1 to 10˜ THz has attracted upsurging attention from academia and industry in recent years. The THz wireless communications have the capability to support Terabit-per-second high data rates, which are envisioned as a pillar candidate for 6th generation (6G) wireless networks.

### SUMMARY

In general, example embodiments of the present disclosure provide a solution of channel estimation for UM-MIMO at THz band.

In a first aspect of the present disclosure, there is provided a first device. The first device comprises at least one processor; and at least one memory storing instructions that, when executed by the at least one processor, cause the first device at least to obtain a first codebook matrix associated with a first antenna arrangement at the first device and a second codebook matrix associated with a second antenna arrangement at a second device, wherein a first plurality of subarrays in the first antenna arrangement are spaced at a predetermined distance from each other, and wherein a second plurality of subarrays in the second antenna arrangement are spaced at a predetermined distance from each other; and characterize a channel between the first device and the second device at least based on the first and the second codebook matrices.

In a second aspect of the present disclosure, there is provided a method. The method comprises obtaining a first codebook matrix associated with a first antenna arrangement at the first device and a second codebook matrix associated with a second antenna arrangement at a second device, wherein a first plurality of subarrays in the first antenna arrangement are spaced at a predetermined distance from each other, and wherein a second plurality of subarrays in the second antenna arrangement are spaced at a predetermined distance from each other; characterizing a channel between the first device and the second device at least based on the first and the second codebook matrices.

In a third aspect of the present disclosure, there is provided an apparatus. The apparatus comprises means for obtaining a first codebook matrix associated with a first antenna arrangement at the first device and a second codebook matrix associated with a second antenna arrangement at a second device, wherein a first plurality of subarrays in the first antenna arrangement are spaced at a predetermined distance from each other, and wherein a second plurality of subarrays in the second antenna arrangement are spaced at a predetermined distance from each other; and means for characterizing a channel between the first device and the second device at least based on the first and the second codebook matrices.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example communication environment in which example embodiments of the present disclosure can be implemented;

FIG. 2 illustrates an example diagram of the antenna arrangement according to some example embodiments of the present disclosure;

FIG. 3 illustrates example results of channel estimation by using different algorithms according to some example embodiments of the present disclosure;

FIG. 4 illustrates a flowchart of a method implemented at a first device according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As described above, the THz spectrum ranging from 0.1 to 10˜ THz has attracted upsurging attention from academia and industry in recent years. The ultra-broad bandwidth of THz wireless communications yet comes at the expense of severe atmospheric attenuation, which brings high propagation losses and constraints on the communication distance. However, the sub-millimeter wavelength of the THz band enables the deployment of UM-MIMO. By employing up to thousands of antennas, the generated razor-sharp beams with strong beamforming gains may overcome the distance limitation problem.

Due to the large reflection, scattering, and diffraction losses, the THz channel is sparse and composed of a Line-of-Sight (LoS) path and only a few Non-Line-of-Sight (NLoS) paths. The THz multi-antenna channels suffer from limited multiplexing imposed by the number of multi-paths instead of the number of antennas as in the microwave.

To enhance the multiplexing, a Widely-Spaced Multi-Subarray (WSMS) antenna array arrangement was proposed. Hereinafter the WSMS antenna array arrangement may also be referred to as the WSMS system or the WSMS architecture. Compared to the compact antenna array arrangement, the subarray spacing in the WSMS system is enlarged. In this way, additional propagation paths are created among the subarrays, which enables additional multiplexing gain associated with the number of subarrays for both the UE side and the gNB side. For example, benefiting from the multiplexing gain due to the enlarged subarray spacing, the spectral efficiency of the WSMS architecture is much higher than that in the compact antenna array arrangement, e.g., 402% higher when transmit power equals to 15 dBm.

However, the beneficial of the WSMS structure relies on accurate antenna level Channel State Information (CSI). Since the enlarged subarray spacing in the WSMS structure extends the near-field region of propagation, the planar-wave assumption-based channel estimation is not valid anymore in the WSMS structure, and therefore the spherical-wave propagation among subarrays needs to be considered. That is, the current channel estimation method may not be properly applied for the WSMS structure due to the difference in the channel propagation property.

Therefore, in a case where the WSMS antenna array arrangement is applied, a mechanism of the channel estimation for the UM-MIMO at THz band is proposed in the present disclosure. A first device obtains a first codebook matrix associated with a first antenna arrangement at the first device and a second codebook matrix associated with a second antenna arrangement at a second device and characterizes a channel between the first device and the second device at least based on the first and the second codebook matrices. The first antenna arrangement comprises a first plurality of subarray spaced at a predetermined distance from each other and the second antenna arrangement comprises a second plurality of subarrays spaced at a predetermined distance from each other.

On the one hand, the proposed solution proposes a subarray-based sparse channel representation codebook suitable for channel estimation of the WSMS structure. On the other hand, two recovery algorithms are proposed to reduce the complexity of channel estimation and meanwhile increase the estimation accuracy.

Example embodiments of the present disclosure will be described in detail below with reference to the accompanying drawings.

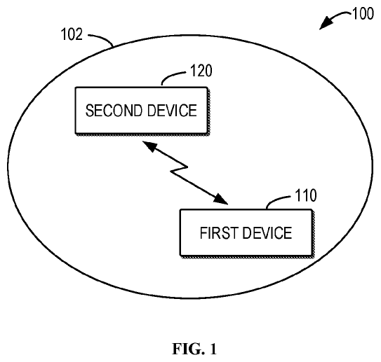

FIG. 1 illustrates an example communication environment 100 in which example embodiments of the present disclosure can be implemented. In the communication environment 100, a plurality of communication devices, including a first device 110 and a second device 120, can communicate with each other.

In the example of FIG. 1, in some scenarios, the first device 110 may include a terminal device and the second device 120 may include a network device serving the terminal device. In some other scenarios, the first device 110 may include a network device serving a terminal device and the second device 120 may include the terminal device.

It is to be understood that the number of devices and their connections shown in FIG. 1 are only for the purpose of illustration without suggesting any limitation. The communication environment 100 may include any suitable number of devices configured to implementing example embodiments of the present disclosure.

In the following, for the purpose of illustration, some example embodiments are described with the first device 110 operating as a network device and the second device 120 operating as a terminal device. However, in some example embodiments, operations described in connection with a network device may be implemented at a terminal device or other device, and operations described in connection with a terminal device may be implemented at a network device or other device.

In some example embodiments, if the first device 110 is a network device and the second device 120 is a terminal device, a link from the second device 120 to the first device 110 is referred to as an uplink (UL), while a link from the first device 110 to the second device 120 is referred to as a downlink (DL). In DL, the first device 110 is a transmitting (TX) device (or a transmitter) and the second device 120 is a receiving (RX) device (or a receiver). In UL, the second device 120 is a TX device (or a transmitter) and the first device 110 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

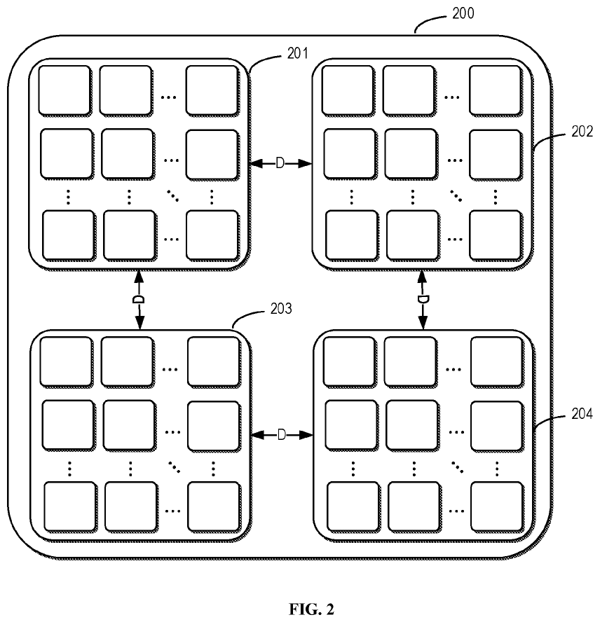

FIG. 2 shows an example diagram of antenna array arrangement 200 according to some example embodiments of the present disclosure. For the purposes of discussion, the diagram 200 will be discussed with reference to FIG. 1, for example, by using the first device 110 and the second device 120.

In some example embodiments, the first antenna arrangement at a Rx side (for example, hereinafter the Rx may be referred to as the first device 110) may have a first plurality of subarrays, which are spaced at a predetermined distance with each other. The second antenna arrangement at the Tx side (for example, hereinafter the Tx may be referred to as the second device 120) may have a second plurality of subarrays, which are spaced at a predetermined distance with each other. That is, both Rx side and the Tx side may be arranged with a WSMS antenna array arrangement.

It is to be understood that the first antenna arrangement and the second antenna arrangement may have a same number or different numbers of subarrays. The predetermined distance between two adjacent subarrays in the first antenna arrangement may be same as or different from the predetermined distance between two adjacent subarrays in the second antenna arrangement.

It is to be understood that the predetermined distance may be set to any suitable value, for example, the predetermined distance may be 256λ, where λ is the wavelength.

As shown in FIG. 2, the WSMS antenna array arrangement 200 may have four subarrays, namely subarrays 201-204, which are spaced at a distance D with each other. Each subarray may be arranged with a plurality of antennas.

The channel estimation in UM-MIMO systems operating in the mm Wave and THz frequencies may adopt the compressive sensing (CS) based channel estimation methods, which may exploit the channel sparsity of the spatial angle domain at mmWave and THz bands and reduce the overhead of beam training. The key point for determining the sparse channel representation may focus on finding the channel representation codebooks.

In some example embodiments of the present disclosure, the first device 110 obtains a first codebook matrix associated with the first antenna arrangement at a Rx and a second codebook matrix associated with the second antenna arrangement at a TX.

For the WSMS antenna array arrangement, the subarray-based codebook may be adopted, which may take each subarray as a unit. The subarray-based codebook may hold a block-diagonal form and deploy grid-of-beam (GoB) codebook based on a subarray in each block. It is to be understood that the single polarization is considered for the WSMS antenna array arrangement in the present disclosure, while 2 polarizations are not precluded.

Specifically, the first codebook matrix may be determined by associating a set of grid-of-beam codebooks with each subarray from the first plurality of subarrays, and wherein the second codebook matrix may be determined by associating the set of grid-of-beam codebooks with each subarray from the second plurality of subarrays.

In some embodiments, diagonal blocks in the first codebook matrix correspond to the respective set of grid-of-beam codebooks associated with each subarray from the first plurality of subarrays and diagonal blocks in the second codebook matrix correspond to the respective set of grid-of-beam codebooks associated with each subarray from the second plurality of subarrays.

For example, at the Rx, the codebook may take virtual angles for each subarray from fixed Nₐᵣ sampled points, where Nₐᵣ=NₐᵣₓN_{arz} represents the number of antennas on one subarray, with Nₐᵣₓ and N_{arz} representing the number of antennas on the x- and z-axis, respectively.

The GoB codebook for the subarray at Rx side can be expressed as:

$$( 1 )$$

$${U}_{GoB} = [ {a}_{UPA}^{{N}_{ar}} ( - 1 , - 1 ) , … , {a}_{UPA}^{{N}_{ar}} ( \frac{2 ( {n}_{arx} - 1 )}{{N}_{arx}} - 1 , \frac{2 ( {n}_{arz} - 1 )}{{N}_{arz}} - 1 ) , … , {a}_{UPA}^{{N}_{ar}} ( \frac{2 ( {N}_{arx} - 1 )}{{N}_{arx}} - 1 , \frac{2 ( {N}_{arz} - 1 )}{{N}_{arz}} - 1 ) ] with dimensions of {N}_{ar} \times {N}_{ar}$$

in which each vector

$${a}_{UPA}^{{N}_{ar}} ( , )$$

may have a form with

$${a}_{UPA}^{N} ( {ψ}_{x} , {ψ}_{z} ) ,$$

for example,

$${ψ}_{x} = \frac{2 ( {n}_{arx} - 1 )}{{N}_{arx}} and {ψ}_{z} = \frac{2 ( {n}_{arz} - 1 )}{{N}_{arz}} - 1.$$

Defining that the channel representation codebook matrix at the Rx, i.e., the first codebook matrix, is represented as U_{Sr}, which deploys Kᵣ U_{GoB} on its diagonal to form a block-diagonal matrix for Kᵣ subarrays at Rx, the first codebook matrix can be expressed as:

$${U}_{Sr} = diag [ {U}_{GoB} , … , {U}_{GoB} ] with dimension of {N}_{r} \times {N}_{r} , \\ where {N}_{r} = {N}_{ar} \times {K}_{r} \qquad ( 2 )$$

The channel representation codebook matrix at Tx, i.e., the second codebook matrix, representing as U_{St} may have a similar form as Equation (2). That is, the first device 110 obtains the first codebook matrix U_{Sr} and the second codebook matrix U_{St}.

The subarray-based codebook may be more suitable for the WSMS structure with nonuniformly distributed antennas and possesses much higher accuracy than the current GoB codebook.

At least based on the above codebook matrices, a channel between the first device 110 and the second device 120 may be characterized as:

$${H}_{HSPM} \approx {U}_{Sr} {AU}_{St}^{H} \qquad ( 3 )$$

where H_{HSPM} represents a channel matrix with hybrid spherical- and planar-wave (HSPM) channel model, which may enhance a propagation modeling in a case where the WSMS antenna array arrangement is applied, U_{Sr} and U_{St} represent the first codebook matrix and the second codebook matrix, respectively, and Λ is an on-grid sparse channel matrix by taking each pair of columns between U_{Sr} and U_{St} as a grid point, that is, each element of on-grid matrix Λ may indicate the channel gain of grid point. Hereinafter the on-grid sparse channel matrix Λ may also be referred to as a channel gain matrix.

Then the first device 110 may determine the on-grid matrix Λ, to recovery the channel.

In some example embodiments, two kinds of sparse recovery algorithms may be applied for the channel recovery, namely a low complexity split Tx and Rx estimation (STRE) and a spatial-correlation based grid reduction estimation (GRE).

The STRE algorithm may split the estimation of non-zero grid points into the Tx and Rx side respectively, by which the searching complexity is reduced from [symbol] (N²) to around [symbol] (N), while the GRE algorithm further reduces the complexity of STRE by the fact that non-zero grid points (or virtual angles) located over different subarrays may be close in the spatial domain.

For example, when the subarray spacing equals to 256λ, the elevation angle difference for the LoS path between subarrays at a typical communication distance in the THz band of 10 m is around 1.5 degrees. The searching complexity of GRE algorithm is further reduced to around [symbol] (N/K), where K denotes the number of subarrays.

In a case where the STRE recovery algorithm is applied, the first device 110 may determine non-zero grid points on a channel gain matrix Λ at least based on the channel representation codebook matrices and the received signal.

A beam training procedure is required to obtain the channel observation for the purpose of channel estimation. During the training, both Tx and Rx generate beams and transmit or receive pilot signal respectively. Each beam is generated by a pre-stored beam codebook, and it is constructed by tuning the value of the phase shift in the analog transmit beamforming and receive combining matrices. Both transmit beamforming and receive combining matrices may hold a block-diagonal structure due to the configuration of the WSMS structure. After Tx and Rx scan all the beam combinations, the received signal may be collected and constructed for the channel estimation. The received signal after beam training procedure can be expressed as:

$$Y = {W}^{H} {H}_{HSPM} F + N \qquad ( 4 )$$

where W and F represent a receive combining matrix and a transmit beamforming matrix of beam training respectively, aggregated in different time instances, and N refers to the received noise. Hereinafter the receive combining matrix W may also be referred to as a first beamforming matrix and the transmit beamforming matrix F may also be referred to as a second beamforming matrix.

It is to be understood that receive combining and transmit beamforming matrices W and F for beam training procedure, as well as block-diagonal codebooks for sparse channel representation may be specified in a RRC signaling to satisfy the requirement of the channel estimation.

The process of the STRE recovery algorithm may be shown as below:

TABLE 1
a process of STRE recovery algorithm

Input: Received signal Y, combined training matrices at Rx and Tx. W and F,
the codebook matrices U_{Sr} and U_{St}
Initialization: Πᵣ = ø, Πₜ = ø, Bᵣ = W^{H}U_{Sr}, Bₜ = F^{H}U_{St}
$Assumptions : {H}_{HSPM} \approx {U}_{Sr} ∧ {U}_{St}^{H} , Y = {W}^{H} {H}_{HSPM} F + N .$

| | |
|---|---|
| 1. | Step 1: Estimate non-zero rows of Λ |
| 2. | ${y}_{sumr} = {\sum }_{i = 1}^{{N}_{t}} ( {YB}_{t} ) ( : , i ) = {\sum }_{i = 1}^{{N}_{t}} ( {W}^{H} {H}_{HSPM} {FB}_{t} + {NB}_{t} ) ( : , i )$ |
| 3. | y = y [symbol] ᵣ, B = Bₜ, I ∝ KᵣKₜNₚ, |
| 4. | Use Algorithm 2 to obtain the estimated grid point Πᵣ |
| 5. | Step 2: Estimate non-zero columns of Λ |
| 6. | ${Y}_{1} = {Y}^{H} , {y}_{sumt} = {\sum }_{i = 1}^{I} ( {Y}_{1} {B}_{r} ) ( : , {Π}_{r} ( i ) ) = {\sum }_{i = 1}^{I} ( {F}^{H} {H}_{HSPM}^{H} {WB}_{r} + {N}^{H} {B}_{r} ) ( : , {Π}_{r} ( i ) )$ |
| 7. | y = y [symbol] , B = Bₜ, I ∝ KᵣKₜNₚ, |
| 8. | Use Algorithm 2 to obtain the estimated grid point Πₜ |
| 9. | Step 3: Recover the channel matrix |
| 10. | Âₜ = Bᵣ(:, Πᵣ), [symbol] ₜ = Bₜ(:, Πₜ) |
| 11. | $\hat{Λ} ( {Π}_{r} , {Π}_{t} ) = {\hat{A}}_{r}^{†} {Y ( {\hat{A}}_{t}^{†} )}^{H}$ |

$Output : Estimated channel \dot{H} = {U}_{Sr} \dot{Λ} {U}_{St}^{B}$ [symbol]
indicates data missing or illegible when filed

The input to the STRE algorithm (hereinafter may also be referred to as Algorithm 1) in Table 1 includes the received signal Y, the collected combining and transmitting matrices of beam training W and F (i.e., the first beamforming matrix and the second beamforming matrix), as well as the channel representation codebook matrices U_{Sr} and U_{St} (i.e., the first codebook matrix and the second codebook matrix). The non-zero grid points at Rx and Tx are stored in Πᵣ and Πₜ, which are initialized to be empty sets.

Defining Bᵣ=W^{H}U_{Sr} and Bₜ=F^{H}U_{St}, in step 1, the row positions of A are estimated for non-zero grid points. Specifically, yₛᵤₘᵣ in Line 2 in Table 1 can be calculated as

$${y}_{sumr} = {\sum }_{i = 1}^{{N}_{t}} ( {YB}_{t} ) ( : , i ) ,$$

wherein “YBₜ” may also be referred to as a first weighted representation of the received signal. Due to the sparsity of Λ, sₛᵤₘᵣ=Bᵣ^{H}yₛᵤₘᵣ is a sparse vector, the non-zero positions in sₛᵤₘᵣ relates to the non-zero rows of Λ. Therefore, the positions of non-zero rows of Λ can be determined by estimating the non-zero positions of sₛᵤₘᵣ.

Specifically, by setting y=yₛᵤₘᵣ, B=Bᵣ and the number of iterations I∝KᵣKₜNₚ, in Line 4 of Table 1, an algorithm for estimating the non-zero positions (as shown below in Table 2 and hereinafter may also be referred to as Algorithm 2) can be adopted to complete the estimation of non-zero rows of Λ, which is collected in the set Πᵣ.

Similarly, in step 2, the column positions of Λ are estimated for non-zero grid points. Since the positions of the non-zero rows of Λ have been determined in the previous stage, using these rows is enough in determining the non-zero columns of Λ collected in Πₜ, which is shown in Line 6 in Table 1. Alternatively, determining column positions of Λ can be independent of row positions of A without constraint on summation operation in Line 6 in Table 1. Followed by that, in step 3, the estimated Aᵣ and Aₜ is first obtained in Line 10 as Âᵣ=Bᵣ(:, Πᵣ) and Âₜ=Bₜ (:, Πₜ). The sparse on-grid channel gain matrix is then estimated in Line 11 in Table 1 as

$$\hat{Λ} ( {Π}_{r} , {Π}_{t} ) = {\hat{A}}_{r}^{+} {Y ( {\hat{A}}_{t}^{+} )}^{H} .$$

Based on these estimated matrices, the channel matrix is finally recovered as

$$\hat{H} = {U}_{Sr} \hat{Λ} {U}_{St}^{H} ,$$

which completes STRE algorithm in Table 1.

For example, a process of estimating the non-zero positions of yₛᵤₘᵣ (Algorithm 2) may be shown as below:

TABLE 2
a process of estimating the non-zero positions

Input: Received signal y, measurement
matrix B, number of iterations I
Initialization: II = Ø, r = y, ŝ = 0_{size(B,2)}
1. for i = 1,...,I
2. n = argmax ||B^{H}r||₂²
3. II = II∪nᵣ
4. ŝ(II) = B^{†}(:, II)y
5. r = y − Bŝ
6. end for
Output: Estimated grid position II

Based on the process shown in Table 2, the details of estimating the positions of non-zero grids with received signal y and measurement matrix B can be further explained. The correlation between the measurement matrix B and the residual vector r may be calculated first. The most correlative column index is expressed as n, which is regarded as the newly found grid index and added to the grid set Π. The estimated signal on the grids specified by Π is calculated.

Then the residual vector is updated by removing the effect of the non-zero grid points in Rx side or Tx side that have been estimated in the previous steps. By repeating these procedures, T indexes are selected as the estimated non-zero grid points in Rx side or Tx side.

Although the example in Table 1 shows a case where the non-zero rows are determined first and then the set of non-zero columns are determined based on the non-zero rows. It is to be understood that the set of non-zero columns may also be determined before the non-zero rows or at the same time with a determination of the non-zero rows. The example shown in Table 1 shall not be limited the scope of the present disclosure.

By using the STRE algorithm, the estimation of the Tx and Rx non-zero grid points may be split, which may reduce the searching complexity, for example, the searching complexity may be reduced from [symbol] (N²) to around [symbol] (N).

Regarding to the GRE algorithm (hereinafter may also be referred to as Algorithm 3), the computational complexity may also be reduced by considering the spatial correlation among subarrays. As described, when the subarray spacing equals to 256λ, the elevation angle difference for the LoS path between two subarrays at a typical communication distance in the THz band of 10 m is only around 1.5 degree. Therefore, for the signal at Rx side, the spatial angles for different subarrays are close in the WSMS channel. If the codebooks for each subarray may be considered separately, the positions of non-zero grid points would be close across subarrays.

Thus, the GRE algorithm may first calculate the positions of the non-zero grid points located in one subarray, which are saved as the benchmark grids. For the remaining subarrays, the grid searching space is reduced by limiting the potential grids in the neighbor of the benchmark grids to reduce the complexity. The value of the neighbor grids depends on the correlation among subarrays, more specifically, the value of which may be enlarged with larger subarray spacing and smaller communication distance.

The process of the GRE algorithm may be shown as below:

TABLE 3
a process of GRE algorithm

Input: Received signal yₛᵤₘ, sensing matrix Φ, codebook matrix for the
subarray U_{sub} number of iterations I, number of subarrays K, number of
beams for a subarray b
Initialization: II = Ø, IIₖ = Ø, N_{α} = size(U_{sub:} 1)

| | |
|---|---|
| 1. | for k = 1 : K |
| 2. | Q = Φ((k − 1) * N_{α} + 1 : kN_{α}, (k − 1) * b + 1 : kb) |
| 3. | yₛᵤₘₖ = yₛᵤₘ ((k − 1) * b + 1 : kb) |
| 4. | if k = 1 |
| 5. | B = Q^{H}U_{sub} |
| 6. | Use Algorithm 2 to obtain the estimated grid point II₁ |
| 7. | else if k > 1 |
| 8. | Construct ĨĨ by selecting the neighboring q grids for |
| | each point in IIₖ₋₁ |
| 9. | B = Q^{H}U_{sub}(:,ĨĨ) |
| 10. | Use Algorithm 2 to obtain the estimated grid point IIₖ |
| 11. | end if |
| 12. | Transform positions in IIₖ to positions in II, II = II ∪ IIₖ |
| 13. | end for |

Output: Estimated grid position II

The grid reduction of the GRE algorithm operates in Step 1 and Step 2 of Algorithm 1, which are detailed in Algorithm 3 and illustrated in Table 3. The input to the GRE algorithm includes the summarized channel observation yₛᵤₘ, the sensing matrix Φ, the codebook for the subarray U_{sub}, number of iterations T, number of subarrays K, and number of beams for a subarray b. In Step 1 of Algorithm 1, these parameters are calculated for non-zero grid searching in row indices of Λ as yₛᵤₘ=yₛᵤₘᵣ, Φ=W, U_{sub}=U_{DFT}, T=Nₚ, K=Kᵣ, and b=bᵣ, where bᵣ denotes number of beams for a subarray at Rx. In Step 2 of Algorithm 1, these parameters are obtained for non-zero grid searching in column indices of Λ as yₛᵤₘ=yₛᵤₘₜ, Φ=F, U_{sub}=U_{DFT}, T=Nₚ, K=Kₜ, and b=bₜ, where bₜ denotes number of beams for a subarray at Tx.

For the k^{th} subarray, the GRE algorithm first obtains its sensing matrix Q as Q=Φ((k−1)*Nₐ+1:kNₐ, (k−1)*b+1:kb) and observation vector yₛᵤₘₖ=yₛᵤₘ((k−1)*b+1:kb) in Line 2 and 3 in Table 3, respectively. For the first subarray when k=1, the non-zero grid points relating to U_{sub} are directly estimated and recorded in Π₁ as the benchmark grids. Specifically, B=Q^{H} U_{sub} is calculated and Algorithm 2 is deployed to obtain the estimated grids in Π₁. If k>1, \tilde{Π} may be constructed by selecting the neighboring q grids for each point in Πₖ₋₁ in Line 8 in Table 3 as the potential searching grids. Therefore, the potential searching grids for each subarray is dynamically updated according to the estimated grid points in the previous subarray. Alternatively, the potential searching grids can be a fixed set \tilde{Π} determined according to the benchmark grids. Then, B=Q^{H} U_{sub}(:, \tilde{Π}) is calculated and Algorithm 2 is deployed to obtain the estimated grids in Πₖ. Finally, in Line 12 in Table 3, positions in Πₖ may be transformed to grid positions for the entire array according to the index of the subarray and saved in Π. Specifically, by numbering the subarray and grid position of each subarray, positions in Πₖ is one-on-one related to points in II.

In this way, compared to the STRE algorithm, the searching complexity may be further reduced by using GRE algorithm, for example, may be reduce to around [symbol] (N/K), where K represents the number of subarrays.

Since the positions of non-zero grid points are determined, the first device 110 may further determine the channel gain on each non-zero grid point and therefore recovery the channel based on the characterized channel (shown in Equation 3).

With the solution of the present disclosure, the inaccuracy of the GoB codebook for WSMS structure may be avoided. Furthermore, the searching overhead associated with the enlarged dimension of the UM-MIMO in the THz band may be reduced due to the STRE and the GRE recovery algorithms.

Some evaluations are made to verify the performance of channel estimation based on the proposed mechanism according to embodiments of the present disclosure. The carrier frequency of 0.3 THz, the bandwidth is 5 GHz for sub-THz system, and the number of antennas of a subarray at Tx and Rx are set as 64 and the number of subarrays is 4. The estimation accuracy is revealed in terms of the normalized-mean-square-error (NMSE), which is defined as

$$𝔼 \{ \frac{{‖ \hat{H} - {H}_{HSPM} ‖}_{F}}{{‖ {H}_{HSPM} ‖}_{F}} \} ,$$

where Ĥ denotes the estimated channel matrix and H_{HSPM} is an ideal channel matrix.

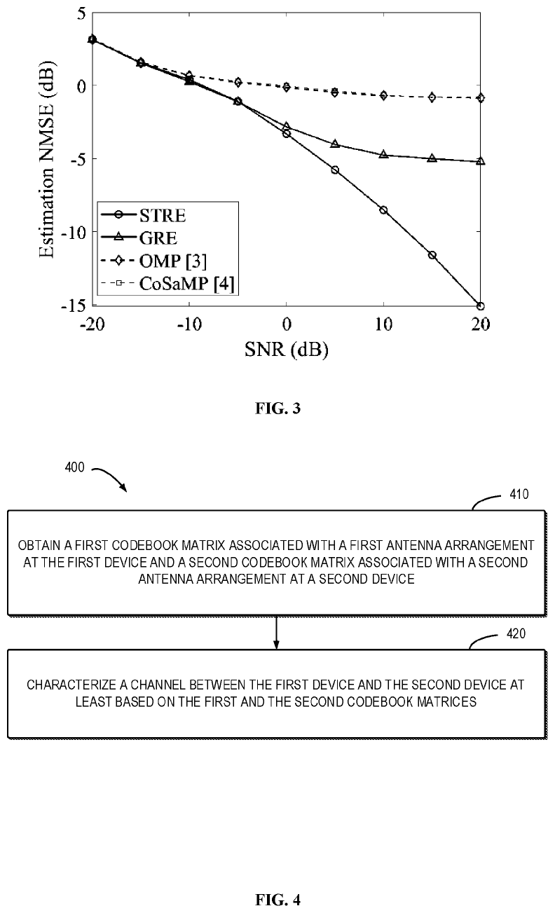

The evaluation of the NMSE performance against the signal-to-noise ratio (SNR) may be shown in FIG. 3. During the training process, the random phase shift coefficient for the training codebook of the WSMS may be considered. The number of neighbor grids in the GRE is fixed as 5 during our simulation.

As shown in FIG. 3, the proposed STRE and GRE methods based on the proposed subarray-based codebook perform much better than the traditional OMP and CoSaMP based on the complete array-based GoB codebook. Specifically, when SNR=0 dB, the estimation NMSE of the OMP and AMP remains close to 0 dB, while the NMSE of the STRE and GRE algorithms are reduced by −2.1 and −2.5 dB compared with the traditional solutions and keep decreasing with the increment of SNR. This result validates the accuracy and effectiveness of the proposed subarray-based codebook in the sub-THz or THz system.

Moreover, it may also be observed that the performance of the low complexity GRE algorithm is close to that of the STRE algorithm at low SNR from −20 to 0 dB. However, the NMSE difference increases as the increment of SNR. This is because, in the GRE, the potential grids error can be avoided by the determination of potential searching grids based on the benchmark grids, especially in noisy condition. However, since the best grids for the entire array cannot be completely mapped to the first subarray, the performance of the GRE becomes worse than the STRE as the SNR increases. To this end, we can conclude that the GRE algorithm is more attractive in the low SNR region.

Comparison results of the computational complexity of the proposed STRE and GRE algorithms with traditional OMP and CoSaMP algorithms may be summarize as below.

TABLE 4
Comparison on computational complexity

| Algorithm | Computational complexity |
|---|---|
| OMP | [symbol] (N²(KNₚ)⁴) |
| CoSaMP | [symbol] (N²(KNₚ)⁴) |
| STRE | [symbol] (N(KNₚ)⁴) |
| GRE | [symbol] (N/K(KNₚ)⁴) |

As shown in Table 4, the number of antennas and subarrays at Tx and Rx are denoted as Nᵣ=Nₜ=N and Kᵣ=Kₜ=K, respectively. Nₚ refers to the number of paths. The complexity of the OMP and CoSaMP algorithms majorly comes from the joint Rx and Rx grid search, which are around [symbol] (N²(KNₚ)⁴). Benefiting from the separate Tx and Rx searching, complexity of the STRE reduces to around [symbol] (N(KNₚ)⁴). Moreover, the spatial correlation further reduces the complexity of the GRE algorithm compared to the STRE, by which the complexity is [symbol] (N/K(KNₚ)⁴). As N becomes large in the UM-MIMO, the relative values of complexity of these algorithms can be approximated as [symbol] (N²), [symbol] (N²), [symbol] (N) and [symbol] (N/K), respectively.

FIG. 4 illustrates a flowchart of a method implemented at a first device according to some example embodiments of the present disclosure. The method 400 may be implemented at the first device 110 as shown in FIG. 1. For the purpose of discussion, the method 400 will be described with reference to FIG. 1.

At 410, the first device 110, obtains a first codebook matrix associated with a first antenna arrangement at the first device and a second codebook matrix associated with a second antenna arrangement at a second device. A first plurality of subarrays in the first antenna arrangement are spaced at a predetermined distance from each other and a second plurality of subarrays in the second antenna arrangement are spaced at a predetermined distance from each other.

In some example embodiments, the first codebook matrix is determined by associating a set of grid-of-beam codebooks with each subarray from the first plurality of subarrays, and wherein the second codebook matrix is determined by associating the set of grid-of-beam codebooks with each subarray from the second plurality of subarrays.

In some example embodiments, diagonal blocks in the first codebook matrix correspond to the respective set of grid-of-beam codebooks associated with each subarray from the first plurality of subarrays and diagonal blocks in the second codebook matrix correspond to the respective set of grid-of-beam codebooks associated with each subarray from the second plurality of subarrays.

At 420, the first device 110 characterizes a channel between the first device and the second device at least based on the first and the second codebook matrices.

In some example embodiments, the firs device 110 may obtain a received signal, a plurality of non-zero grid points at least based on the first and the second codebook matrices and the received signal, a grid point being associated with a pair of vectors selected from the first and the second codebook matrices respectively; and characterize the channel based on channel gain associated with the plurality of non-zero grid points and the first and the second codebook matrices.

In some example embodiments, the firs device 110 may obtain a first beamforming matrix and a second beamforming matrix and determine a first weighted representation of the received signal based on the second beamforming matrix, and the second codebook matrix and a second weighted representation of the received signal based on the first beamforming matrix and the first codebook matrix. The first device 110 may further determining a set of non-zero rows at least based on the first weighted representation of the received signal and a set of non-zero columns at least based on the second weighted representation of the received signal; and; and determine the determined non-zero grid points based on the determined set of non-zero rows and the set of non-zero columns.

In some example embodiments, the firs device 110 may determine the set of non-zero columns based on the second weighted representation of the received signal and the determined set of non-zero rows, if the set of non-zero rows are determined.

In some example embodiments, the firs device 110 may determine the set of non-zero rows based on the first weighted representation of the received signal and the determined set of non-zero columns, if the set of non-zero columns are determined.

In some example embodiments, the firs device 110 may select a reference subarray from the first or the second plurality of subarrays and determine a first plurality of non-zero rows or columns on the reference subarray. The firs device 110 may further determine a second plurality of non-zero rows or columns on a further subarray from the first or the second plurality of subarrays based on a grid searching space associated with the first plurality of determined non-zero rows or columns on the reference subarray; and determine the plurality of non-zero grid points at least based on the first and the second plurality of non-zero rows or columns.

In some example embodiments, the grid searching space comprises at least one of the first plurality of determined non-zero rows or columns, rows adjacent to the first plurality of determined non-zero rows within a predetermined range; or columns adjacent to the first plurality of determined non-zero columns within a predetermined range.

In some example embodiments, the first device comprises a terminal device and the second device comprises a network device; or the first device comprises the network device and the second device comprises the terminal device.

In some example embodiments, an apparatus capable of performing the method 400 (for example, implemented at the first device 110) may include means for performing the respective steps of the method 400. The means may be implemented in any suitable form. For example, the means may be implemented in a circuitry or software module.

In some example embodiments, the apparatus comprises means for determining a first codebook matrix associated with a first antenna arrangement at the first device and a second codebook matrix associated with a second antenna arrangement at a second device, wherein a first plurality of subarrays in the first antenna arrangement are spaced at a predetermined distance from each other, and wherein a second plurality of subarrays in the second antenna arrangement are spaced at a predetermined distance from each other; and means for characterizing a channel between the first device and the second device at least based on the first and the second codebook matrices.

In some example embodiments, the first codebook matrix is determined by associating a set of grid-of-beam codebooks with each subarray from the first plurality of subarrays, and wherein the second codebook matrix is determined by associating the set of grid-of-beam codebooks with each subarray from the second plurality of subarrays.

In some example embodiments, diagonal blocks in the first codebook matrix correspond to the respective set of grid-of-beam codebooks associated with each subarray from the first plurality of subarrays and diagonal blocks in the second codebook matrix correspond to the respective set of grid-of-beam codebooks associated with each subarray from the second plurality of subarrays.

In some example embodiments, the means for characterizing the channel further comprises means for obtaining a received signal; means for determining a plurality of non-zero grid points at least based on the first and the second codebook matrices and the received signal, a grid point being associated with a pair of vectors selected from the first and the second codebook matrices respectively; and means for characterizing the channel based on channel gain associated with the plurality of non-zero grid points and the first and the second codebook matrices.

In some example embodiments, the means for determining non-zero grid points comprises means for obtaining a first beamforming matrix and a second beamforming matrix; means for determining a first weighted representation of the received signal based on the second beamforming matrix and the second codebook matrix, and a second weighted representation of the received signal based on the first beamforming matrix and the first codebook matrix; means for determining a set of non-zero rows at least based on the first weighted representation of the received signal and a set of non-zero columns at least based on the second weighted representation of the received signal; and means for determining the non-zero grid points based on the determined set of non-zero rows and the determined set of non-zero columns.

In some example embodiments, the means for determining the set of non-zero columns comprises means for in accordance with a determination that the set of non-zero rows are determined, determining the set of non-zero columns based on the second weighted representation of the received signal and the determined set of non-zero rows.

In some example embodiments, the means for determining the set of non-zero rows comprises means for in accordance with a determination that the set of non-zero columns are determined, determining the set of non-zero rows based on the first weighted representation of the received signal and the determined set of non-zero columns.

In some example embodiments, the means for determining non-zero grid points comprises means for selecting a reference subarray from the first or the second plurality of subarrays; means for determining a first plurality of non-zero rows or columns on the reference subarray; means for determining a second plurality of non-zero rows or columns on other subarrays in the first or the second plurality of subarrays based on a grid searching space associated with the first plurality of determined non-zero rows or columns on the reference subarray; and means for determining he plurality of non-zero grid points at least based on the first and the second plurality of non-zero rows or columns.

In some example embodiments, the grid searching space comprises at least one of the first plurality of determined non-zero rows or columns, rows adjacent to the first plurality of determined non-zero rows within a predetermined range; or columns adjacent to the first plurality of determined non-zero columns within a predetermined range.

In some example embodiments, the first device comprises a terminal device and the second device comprises a network device; or the first device comprises the network device and the second device comprises the terminal device.

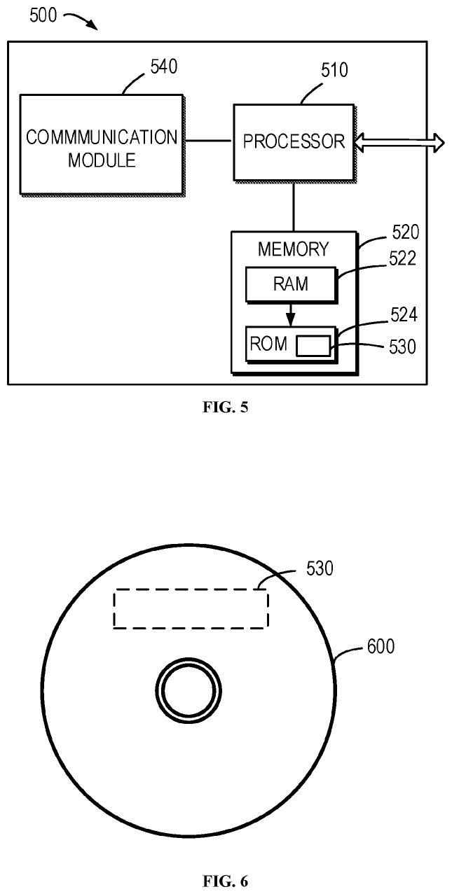

FIG. 5 is a simplified block diagram of a device 500 that is suitable for implementing example embodiments of the present disclosure. The device 500 may be provided to implement a communication device, for example, the first device 110 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to:
obtain a first codebook matrix associated with a first antenna arrangement at the first device and a second codebook matrix associated with a second antenna arrangement at a second device, wherein a first plurality of subarrays in the first antenna arrangement are spaced at a predetermined distance from each other, and wherein a second plurality of subarrays in the second antenna arrangement are spaced at a predetermined distance from each other; and
characterize a channel between the first device and the second device at least based on the first and the second codebook matrices.

2. The first device of claim 1, wherein the first codebook matrix is determined by associating a set of grid-of-beam codebooks with each subarray from the first plurality of subarrays, and wherein the second codebook matrix is determined by associating the set of grid-of-beam codebooks with each subarray from the second plurality of subarrays.

3. The first device of claim 1, wherein diagonal blocks in the first codebook matrix correspond to the respective set of grid-of-beam codebooks associated with each subarray from the first plurality of subarrays and diagonal blocks in the second codebook matrix correspond to the respective set of grid-of-beam codebooks associated with each subarray from the second plurality of subarrays.

4. The first device of claim 1, wherein the first device is further caused to:
obtain a received signal;
determine a plurality of non-zero grid points at least based on the first and the second codebook matrices and the received signal, a grid point being associated with a pair of vectors selected from the first and the second codebook matrices respectively; and
characterize the channel based on channel gain associated with the plurality of non-zero grid points and the first and the second codebook matrices.

5. The first device of claim 4, wherein the first device is further caused to:
obtain a first beamforming matrix and a second beamforming matrix;
determine a first weighted representation of the received signal based on the second beamforming matrix and the second codebook matrix, and a second weighted representation of the received signal based on the first beamforming matrix and the first codebook matrix;
determine a set of non-zero rows at least based on the first weighted representation of the received signal, and a set of non-zero columns at least based on the second weighted representation of the received signal; and
determine the non-zero grid points based on the determined set of non-zero rows and the determined set of non-zero columns.

6. The first device of claim 5, wherein the first device is further caused to:
in accordance with a determination that the set of non-zero rows are determined, determine the set of non-zero columns based on the second weighted representation of the received signal and the determined set of non-zero rows.

7. The first device of claim 5, wherein the first device is further caused to:
in accordance with a determination that the set of non-zero columns are determined, determine the set of non-zero rows based on the first weighted representation of the received signal and the determined set of non-zero columns.

8. The first device of claim 4, wherein the first device is further caused to:
select a reference subarray from the first or the second plurality of subarrays;
determine a first plurality of non-zero rows or columns on the reference subarray;
determine a second plurality of non-zero rows or columns on a further subarray from the first or the second plurality of subarrays based on a grid searching space associated with the first plurality of determined non-zero rows or columns on the reference subarray; and
determine the plurality of non-zero grid points at least based on the first and the second plurality of non-zero rows or columns.

9. The first device of claim 8, wherein the grid searching space comprises at least one of the following:
the first plurality of determined non-zero rows or columns;
rows adjacent to the first plurality of determined non-zero rows within a predetermined range; or
columns adjacent to the first plurality of determined non-zero columns within a predetermined range.

10. The second device of claim 1, wherein
the first device comprises a terminal device and the second device comprises a network device; or
the first device comprises the network device and the second device comprises the terminal device.

11. A method comprising:
determining, at the first device, a first codebook matrix associated with a first antenna arrangement at the first device and a second codebook matrix associated with a second antenna arrangement at a second device, wherein a first plurality of subarrays in the first antenna arrangement are spaced at a predetermined distance from each other, and wherein a second plurality of subarrays in the second antenna arrangement are spaced at a predetermined distance from each other; and
characterizing a channel between the first device and the second device at least based on the first and the second codebook matrices.

12. The method of claim 11, wherein the first codebook matrix is associating a set of grid-of-beam codebooks with each subarray from the first plurality of subarrays, and wherein the second codebook matrix is determined by associating the set of grid-of-beam codebooks with each subarray from the second plurality of subarrays.

13. The method of claim 11, wherein diagonal blocks in the first codebook matrix correspond to the respective set of grid-of-beam codebooks associated with each subarray from the first plurality of subarrays and diagonal blocks in the second codebook matrix correspond to the respective set of grid-of-beam codebooks associated with each subarray from the second plurality of subarrays.

14. The method of claim 11, wherein characterizing the channel comprises:
obtaining a received signal;
determining a plurality of non-zero grid points at least based on the first and the second codebook matrices and the received signal, a grid point being associated with a pair of vectors selected from the first and the second codebook matrices respectively; and
characterizing the channel based on channel gain associated with the plurality of non-zero grid points and the first and the second codebook matrices.

15. The method of claim 14, wherein determining the non-zero grid points comprises:
obtaining a first beamforming matrix and a second beamforming matrix;
determining a first weighted representation of the received signal based on the second beamforming matrix and the second codebook matrix, and a second weighted representation of the received signal based on the first beamforming matrix and the first codebook matrix;
determining a set of non-zero rows at least based on the first weighted representation of the received signal and a set of non-zero columns at least based on the second weighted representation of the received signal; and
determining the non-zero grid points based on the determined set of non-zero rows and the determined set of non-zero columns.

16. The method of claim 15, wherein determining the set of non-zero columns comprises:
in accordance with a determination that the set of non-zero rows are determined, determining the set of non-zero columns based on the second weighted representation of the received signal and the determined set of non-zero rows.

17. The method of claim 15, wherein determining the set of non-zero rows comprises:
in accordance with a determination that the set of non-zero columns are determined, determining the set of non-zero rows based on the first weighted representation of the received signal and the determined set of non-zero columns.

18. The method of claim 14, wherein determining the non-zero grid points comprises:
selecting a reference subarray from the first or the second plurality of subarrays;
determining a first plurality of non-zero rows or columns on the reference subarray;
determining a second plurality of non-zero rows or columns on a further subarray from the first or the second plurality of subarrays based on a grid searching space associated with the first plurality of determined non-zero rows or columns on the reference subarray; and
determining the plurality of non-zero grid points at least based on the first and the second plurality of non-zero rows or columns.

19. (canceled)

20. The method of claim 11, wherein
the first device comprises a terminal device and the second device comprises a network device; or
the first device comprises the network device and the second device comprises the terminal device.

21. (canceled)

22. A non-transitory computer readable medium comprising program instructions for causing an apparatus to perform at least the method of claim 11.
